(19) United States
(12) Patent Application Publication
(10) Pub. No.: US 2013/0005858 A1
(43) Pub. Date: Jan. 3, 2013

(54) INSULATING POLYMER MATERIAL COMPOSITION

(75) Inventors: Tadayuki Wada, Nagoya-shi (JP); Akihiro Kurosumi, Toda-shi (JP); Yasuyuki Kurata, Yokohama-shi (JP)

(73) Assignees: MEIDENSHA CORPORATION; Chubu Electric Power Co., Inc.

(21) Appl. No.: 13/583,813

(22) PCT Filed: Mar. 9, 2011
(86) PCT No.: PCT/JP2011/055461

§ 371 Date: Sep. 10, 2012

(30) Foreign Application Priority Data
Mar. 11, 2010 (JP) 2010-053968

(51) Int. Cl. C08L 63/00; C08K 3/22

(52) U.S. Cl. 523/458

(57) ABSTRACT

An insulating polymer material composition of the environment-conscious type which is obtained by using a renewable resource and a waste material as starting materials is provided. A vegetable oil-origin epoxy resin and a plant-origin polyphenol are mixed and the obtained mixture is subjected to a heat treatment, with which a liquid epoxy resin composition which is a compatibilized blend of the vegetable oil-origin epoxy resin and the plant-origin polyphenol is provided. To this liquid epoxy resin composition, coal ash and a silane coupling agent are added followed by mixing. Further, an additive such as a curing accelerator is added thereto, followed by a heat treatment, thereby obtaining an insulating polymer material composition. As the coal ash, it is preferable to use fly ash. It is also preferable to use a silane coupling agent having epoxy group.

### TECHNICAL FIELD

The present invention relates to an insulating polymer material composition and more particularly to that suitable for insulating a high-voltage and high-temperature electric power system, and additionally relates to an insulating polymer material composition which can be used as an alternative to thermosetting resins such as unsaturated polyester resins, epoxy resins and the like in conventional insulating materials.

### BACKGROUND OF THE INVENTION

As an insulating material or a structural material for high-voltage devices, there has widely been used a cured polymer composite that uses as a matrix a thermosetting resin exemplified by a petroleum-origin epoxy resin obtained by using petroleum as the starting material, the cured polymer composite being the so-called molded product. Then, together with the recent trend toward sophistication and centralization of society, the devices have been intensely desired to provide a larger capacity, a smaller size and a greater reliability and therefore molded products have become increasingly significant.

However, thermosetting resins used for these molded products are derived from petroleum-origin materials, and therefore it is required to use a renewable resource in the future from the viewpoint of global issues such as exhaustion of petroleum resources. In view of this, a technique that relates to using plant-origin materials as epoxy resin and as a curing agent therefor has been suggested (Patent Publications 1 to 3).

For example, in Patent Publication 1, there are proposed a technique of using a plant-origin material as a curing agent for epoxy resin and a technique of changing a plant-origin material into phenol resin. Furthermore, in Patent Publication 2 there is also suggested a technique relating to an insulating composition formed of a plant-origin epoxy resin.

Additionally, the molded products used for various kinds of purposes are produced in such a manner as to subject a resin composition to a heat treatment or the like to once bring it into a state having flowability and then shape it in a certain mold into a desired shape. For the purpose of improving or increasing mechanical properties, an inorganic filler typified by silica, calcium carbonate, talc and the like has conventionally been added to the resin composition (for example, in Patent Publications 4 to 6).

A resin for molded product used in power generators, power substation facilities or the like is required to exhibit performances including a heat resistance, a low coefficient of thermal expansion, a little dielectric loss in the high-frequency region and the like; hence, fused silica has hitherto been used as an inorganic filler. In addition, from the viewpoint of a heat cycle resistance and the like, the inorganic filler has become required to have a high density filling ability. In order to achieve the high density filling ability, spherical fused silica is used.

### REFERENCES ABOUT PRIOR ART

### Patent Publication

Patent Publication 1: Japanese Patent Application Publication No. 2002-53699
Patent Publication 2: Japanese Patent Application Publication No. 2007-35337
Patent Publication 3: Japanese Patent Application Publication No. 2002-358829
Patent Publication 4: Japanese Patent Application Publication No. 2007-211252
Patent Publication 5: Japanese Patent Application Publication No. 2009-167261
Patent Publication 6: Japanese Patent Application Publication No. 9-77851

### SUMMARY OF THE INVENTION

### Problems to be Solved by the Invention

In the technique discussed in Patent Publication 1, however, phenol resin derived from petroleum is used as a curing agent for epoxidized linseed oil and therefore the plant content is low. This is therefore difficult to be regarded as an insulating cured compound that uses a nonpetroleum material as the starting material which compound can serve as an alternative to conventional thermosetting resins. In addition, this compound has a composition that is excellent in mechanical properties in room temperature but not thoughtful about high temperature properties. Hence this compound has been difficult to be applied to molded products. In fact, examples thereof are directed to a printed wiring board and not constituted for insulating high-voltage devices. Additionally, details of the technique of changing a plant-origin material into phenol resin are not clearly discussed in examples.

Also in the technique suggested by Patent Publication 2, phenol resin derived from petroleum is used as a curing agent for epoxidized linseed oil and therefore the plant content is low. Accordingly this technique cannot provide a perfect alternative to conventional thermosetting resins in the future for a long period of time.

Though fused silica is manufactured by fusing a high purity quartzite (silica, SiO₂) at high temperature, the price of LPG used as a fuel at the time of fusing is increasing with recent surging oil prices. Furthermore, the surging oil prices also have an impact on the cost for the material distribution. Hence an inorganic filler which is inexpensive, available in large quantity and corresponds to fused silica is eagerly desired.

### Means for Solving the Problems

In view of the above, an insulating polymer material composition according to the present invention able to solve the above-mentioned problems is characterized by comprising: one or more kinds of epoxidized vegetable oil; one or more kinds of plant-origin polyphenol derivative; coal ash; and a silane coupling agent.

Additionally, in the insulating polymer material composition, there is an embodiment wherein the silane coupling agent has an epoxy group.

Additionally, in the insulating polymer material composition, there is an embodiment wherein the silane coupling agent has a mercapto group.

Additionally, in the insulating polymer material composition, it is preferable that the silane coupling agent is a combination of two or more kinds of silane coupling agent.

Additionally, in the insulating polymer material composition, it is preferable that the plant-origin polyphenol derivative has two or more hydroxyl groups in one molecule.

Additionally, in the insulating polymer material composition, it is preferable that the plant-origin polyphenol derivative is a gallic acid derivative.

Additionally, in the insulating polymer material composition, there is an embodiment wherein the gallic acid derivative contains any one or more kinds of pyrogallol, methyl gallate, ethyl gallate, propyl gallate, isopropyl gallate, pentyl gallate, isopentyl gallate, hexadecyl gallate, heptadecyl gallate and octadecyl gallate.

Additionally, in the insulating polymer material composition, there is an embodiment wherein the plant-origin polyphenol derivative is lignin.

Additionally, in the insulating polymer material composition, it is preferable that the epoxidized vegetable oil is an epoxidized linseed oil.

### Effects of the Invention

According to the inventions as discussed above, it becomes possible to obtain an insulating polymer material composition that contributes to the reduction of environmental load.

### BRIEF DESCRIPTION OF THE DRAWINGS

FIG. 1 A characteristic diagram showing a relation between the amount of the added silane coupling agent (KBM-403) and the maximum bending stress.

FIG. 2 (a) A characteristic diagram showing a relation between the amount of the added silane coupling agent (KBM-573) and the maximum bending stress.

(b) A characteristic diagram showing a relation between the amount of the added silane coupling agent (KBM-603) and the maximum bending stress.

FIG. 3 A characteristic diagram showing a relation between the amount of the added silane coupling agent (KBM-803) and the maximum bending stress.

### DETAILED DESCRIPTION OF THE INVENTION

The present invention relates to an insulating polymer material composition of the environment-conscious type which is obtained by using a waste coal ash as a filler for a liquid epoxy resin composition in which plant-origin materials are used both for epoxy resin and for a curing agent. The present invention also relates to an electric device provided with the insulating polymer material composition of the environment-conscious type as an insulating material.

An epoxy resin material which can achieve properties required of an industrial material is derived from petroleum. On the other hand, material able to form a three-dimensional cross-linking, even if being a natural material, behaves as an alternative to the material for epoxy resin; therefore an insulating material composition derived from a natural material is not regarded as generating a further carbon dioxide since it is carbon neutral even upon being disposed by incineration.

Then, attention is being given to a vegetable oil-origin epoxy resin, as an epoxy resin using a natural material as the starting material. A vegetable oil-origin epoxy resin is required only to be one that accomplishes epoxidization, and exemplified by epoxidized linseed oil, epoxidized soybean oil and the like.

For example, epoxidized linseed oil is widely used as a stabilizer for polyvinyl chloride, similarly to epoxidized soybean oil. However, epoxidized linseed oil has a reactivity poorer than that of the usual industrial epoxy resin thereby taking time to cure, and low both in Tg (glass transition temperature) and mechanical strength; therefore, it has not been considered to be an insulating or structural material.

This time, as a result of studying epoxidized linseed oil in terms of improvement of Tg, it was found that a cured compound obtained from epoxidized linseed oil has great insulating properties and has more excellent mechanical properties at high temperatures than those of industrial epoxy resins, and additionally it was found possible to obtain superior properties to conventional epoxy resins. In the present invention, accordingly, epoxidized linseed oil is not placed as an auxiliary material such as a plasticizer and the like but placed as an alternative to an epoxy resin material by itself.

Also as a curing agent to be reacted with the above-mentioned epoxidized vegetable oil, attention was given to a natural material. A chemical substance to be reacted with epoxy resin is represented by an amine-based one, an acid anhydride-based one, a phenol-based one, an imidazole-based one and the like, but all of them use a petroleum material as the starting material.

In view of this, as a curing agent using a natural material as the starting material, the target of study was focused on plant-origin polyphenols. The term “plant-origin polyphenols” is a generic name for plant components having two or more phenolic hydroxyl groups (i.e., a hydroxyl group bonded to an aromatic ring such as a benzene ring, a naphthalene ring and the like) within the molecule, and refers to substances synthesized through photosynthesis that plants carry out. It is possible to cite concretely gallic acid, tannin, flavonol, isoflavone, catechin, quercetin, anthocyanin and the like. Additionally, by using them as a raw material, various grades of chemicals can be produced.

In the present invention, as one example of plant-origin polyphenols, attention is given to gallic acid derivatives and lignin. Examples of gallic acid derivatives include methyl gallate, ethyl gallate, butyl gallate, pentyl gallate, propyl gallate, isopropyl gallate, isopentyl gallate, octyl gallate, decyl gallate, dodecyl gallate, tridecyl gallate, tetradecyl gallate, pentadecyl gallate, hexadecyl gallate, heptadecyl gallate, octadecyl gallate, pyrogallol and the like. Of these gallic acid derivatives, those having low molecular weights and low melting points, such as propyl gallate, isopropyl gallate and pyrogallol are preferable.

Meanwhile, lignin is not particularly limited, and therefore it is preferable to employ: kraft lignin having a modified molecular structure and obtained upon extracting carbohydrates such as cellulose and the like from lumber in the pulp and paper industry; an exploded lignin obtained by conducting an explosion treatment on lumber etc. (the explosion conditions therefor are not particularly limited) and then performing extraction with alcohol; or the like.

The mixture ratio between a vegetable oil-origin epoxy resin and plant-origin polyphenols is not particularly limited, so that the additive amount may be determined according to properties of a finally obtained cured compound. For example, it is preferable that the mixture ratio between a vegetable oil-origin epoxy resin and plant-origin polyphenols stands at 5 to 80 parts by weight, preferably 30 to 50 parts by weight of plant-origin polyphenols relative to 100 parts by weight of a vegetable oil-origin epoxy resin.

For a curing accelerator, it is possible to use an imidazole-based one, tertiary amine, aromatic amine and the like. The additive amount of the curing accelerator is not particularly limited and it may be determined according to properties of a finally obtained cured compound. For example, it may be added in an amount of from 0.01 to 5 parts by weight relative to 100 parts by weight of a vegetable oil-origin epoxy resin.

An insulating polymer material composition relating to embodiments of the present invention is filled with coal ash behaving as an inorganic filler. Coal ash is a substance ejected by coal-fired power plants and the like and contains silica and alumina as the principal component. In general, coal ash is classified according to a place at which it is formed, into three kinds including fly ash, cinder ash and clinker ash. Fly ash is a coal ash taken by using a dust collector, from a flue gas that rises from a coal dust combustion boiler. Cinder ash is a coal ash which falls and taken when a flue gas of the coal dust combustion boiler passes through an air preheater, an economizer and the like. Furthermore, clinker ash is a coal ash taken from a furnace bottom of the coal dust combustion boiler onto which it falls. It is possible to use them singly or in combination. Though examples as discussed below show examples where the composition is filled with fly ash, embodiments of the present invention include patterns using the other coal ashes.

Coal ash is spherical substances voluminously ejected from coal-fired power plants, and is known to improve in fluidity in the case of being used as a molding material. For example, fluidity of concrete is improved when coal ash is mixed as a concrete admixture. Coal ash is classified by using a classifier, and coal ash ranging from fine particles to ultrafine particles is mass-produced as a classified fly ash. Coal ash is thus an ejected component and therefore good in cost efficiency. Additionally, it can be said to be an alternative to an inorganic filler that accomplishes the improvement of cost efficiency and the reduction of environmental load since its properties such as hardness, coefficient of thermal expansion and the like are equal to those of spherical fused silica.

The mixture ratio of coal ash is not particularly limited and it may be determined suitably according to, a desired insulating polymer material composition. However, in the case where the mixture ratio is excessively high, there arises a fear of impairing miscibility and moldability. Concerning the mixture amount of coal ash, a molding operation can be achieved if coal ash is mixed up to 550 parts by weight relative to 100 parts by weight of a plant-origin epoxy resin. In order to obtain a better cured compound, the mixture amount of coal ash is preferably 150 to 350 parts by weight relative to 100 parts by weight of a plant-origin epoxy resin.

However, coal ash has a poor compatibility with an epoxidized vegetable oil, so that in the case of being used as an inorganic filler as it is, there comes about a problem of reduction of the strength of the cured compound or a problem of a defective molding accompanied with the viscosity increase. Accordingly, to the insulating polymer material composition of the present invention, a silane coupling agent is added. The silane coupling agent is to improve dispersibility at the time of mixing when resin and a filler is composited, and improve the composite material in mechanical strength, water resistance, heat resistance, transparency and adhesiveness. Moreover, on a thermosetting resin, outstanding effects are provided by virtue of improvement in chemical bond and in compatibility with polymer.

As the silane coupling agent, it is possible to cite a silane coupling agent having a functional group such as epoxy group, amino group, mercapto group, carboxyl group, vinyl group, isocyanate group, isocyanurate, halogen and the like. Concrete examples of the silane coupling agent are: epoxy group-containing silanes such as γ-glycidoxypropyltrimethoxysilane, γ-glycidoxypropyltriethoxysilane, γ-glycidoxypropylmethyldimethoxysilane, β-(3,4-epoxycyclohexyl)ethyltrimethoxysilane, β-(3,4-epoxycyclohexyl)ethyltriethoxysilane and the like; amino group-containing silanes such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-ureidepropyltrimethoxysilane, N-phenyl-γ-aminopropyltrimethoxysilane, N-benzyl-γ-aminopropyltrimethoxysilane, N-vinylbenzyl-γ-aminopropyltriethoxysilane and the like; mercapto group-containing silanes such as γ-mercaptopropyltrimethoxysilane, γ-mercaptopropyltriethoxysilane, γ-mercaptopropylmethyldimethoxysilane, γ-mercaptopropylmethyldiethoxysilane and the like; etc. In addition, there may be used isocyanate group-containing silanes such as γ-isocyanatepropyltrimethoxysilane, γ-isocyanatepropyltriethoxysilane, γ-isocyanatepropylmethyldiethoxysilane and the like, carboxysilanes such as β-carboxyethyltriethoxysilane, β-carboxyethylphenylbis(2-methoxyethoxy)silane and the like, vinyl type unsaturated group-containing silanes such as vinyltrimethoxysilane vinyltriethoxysilane and the like, halogen-containing silanes such as γ-chloropropyltrimethoxysilane and the like, isocyanurate silanes such as tris(trimethoxysilyl)isocyanurate and the like, etc.

The silane coupling agent used in the present invention is normally used within a range of from 0.01 to 5 parts by weight relative to 100 parts by weight of coal ash. It is particularly preferable to use it within a range of from 0.2 to 2 parts by weight relative to 100 parts by weight of coal ash.

The insulating polymer material composition relating to the embodiments of the present invention can be produced by undergoing: a process of mixing a vegetable oil-origin epoxy resin and a plant-origin polyphenol (a mixing process), followed by a process of preheating it at a certain temperature to obtain a liquid compatibilized blend (a liquid epoxy resin composition) in which a part of the vegetable oil-origin epoxy resin and a part of the plant-origin polyphenol take a cross-linking structure (a compatibilizing process); and a process of adding coal ash and a silane coupling agent to the liquid compatibilized blend and then conducting a heat treatment thereon to form cross-linking between the vegetable oil-origin epoxy resin and the plant-origin polyphenol (a curing process).

More specifically, a vegetable oil-origin epoxy resin (a liquid) serving as a primary agent is mixed with a plant-origin polyphenol (a solid) serving as a curing agent at room temperature (the mixing process). In the mixing process, a temperature at the time of mixing the vegetable oil-origin epoxy resin and the plant-origin polyphenol is not particularly limited but required only to be room temperature.

Then, the thus obtained mixture is preheated to cause compatibilization (the compatibilizing process). In the present invention, compatibilization refers to a state where a mixture of a primary agent and a curing agent has a clear appearance. By having the mixture compatibilized, a liquid compatibilized blend (i.e., a liquid epoxy resin composition) in which a part of the vegetable oil-origin epoxy resin and a part of the plant-origin polyphenol take a cross-linking structure is obtained. The range of the cross-linking in the liquid epoxy resin composition is from 1 to 80%, preferably from 1 to 50%, and more preferably from 1 to 20%. The range of the cross-linking in the liquid epoxy resin composition may be controlled by a heating temperature and a heating time for the liquid epoxy resin composition. The viscosity of the liquid epoxy resin composition is preferably not higher than 10000 mPa·s at 80° C., and more preferably not higher than 1000 mPa·s at 80° C.

When the solid curing agent is exhausted from the liquid epoxy resin composition, the liquid epoxy resin composition is cooled below the preheating temperature to slow down the reaction rate.

Under the condition of low reaction rate, the liquid epoxy resin composition is subjected to the addition of coal ash, a silane coupling agent and various kinds of additives (e.g. a property improver and the like) and then the addition of a curing accelerator and the like, followed by a heat treatment. With this, the vegetable oil-origin epoxy resin and the plant-origin polyphenol can fully form cross-linking thereby giving an insulting cured compound (an insulating polymer material composition).

In the compatibilizing process, it is preferable to carry out preheating above the melting point of the plant-origin polyphenol and additionally a compatibilizing time requires to be adjusted according to temperature conditions. The compatibilizing time can be shortened by stirring. However, an excessively long compatibilizing time may cure the liquid epoxy resin, so that it is preferable to determine optimal compatibilizing conditions (including a preheating time and a preheating temperature) on every kind of the curing agent to be added to the liquid epoxy resin.

Concretely referring now to Examples 1 to 3, an insulating polymer material composition relating to the present invention and a process for producing the same will be discussed below. Incidentally, the insulating polymer material composition according to the present invention is not limited to the following Examples 1 to 3. The reaction conditions, the mixture ratio and the like may suitably be modified within a range which does not impair the effects of the invention. For example, compatibilization of an epoxidized vegetable oil with a plant-origin polyphenol may not be performed at the time of producing the insulating polymer material composition, and more specifically, an epoxidized vegetable oil, a plant-origin polyphenol, fly ash, a silane coupling agent, a curing accelerator and the like may be mixed together at the same time.

### Example 1

An insulating polymer material composition relating to Example 1 of the present invention is a composition obtained by adding fly ash and a silane coupling agent to a plant-origin resin composition containing epoxidized linseed oil and pyrogallol. In Example 1, a silane coupling agent having epoxy group was added.

As a vegetable oil-origin epoxy resin, there was used an epoxidized linseed oil (an epoxidized linseed oil manufactured at Daicel Chemical Industries, Ltd. under the trade name of DIMAC L-500) belonging to an epoxidized vegetable oil. Meanwhile, pyrogallol (manufactured at Fuji Chemical Industry Co., Ltd.) serving as one kind of gallic acid derivatives was used as a curing agent for the epoxidized linseed oil.

Concerning fly ash, a II-type fly ash (manufactured at TechnoChubu Co., Ltd.) produced from fly ash ejected by Hekinan coal-fired power plant was used. Though there are some differences in property among aimed insulating polymer compositions according to differences of kind and particle size of fly ash, in every case there was obtained a cured compound excellent in environmental property and in cost efficiency.

As the silane coupling agent, a silane coupling agent having epoxy group was used. More specifically, KBM-403 manufactured at Shin-Etsu Chemical Co., Ltd. was used.

As a curing accelerator, 2-ethyl-4-methylimidazole (manufactured at SHIKOKU CHEMICALS CORPORATION under the trade name of CUREZOL 2E4MZ) was used. Also in the case of using tertiary amine (manufactured at Meiden Chemical Co., Ltd. under the trade name of L-86) or aromatic amine (manufactured at Meiden Chemical Co., Ltd. under the trade name of K-61B) as the curing agent, similar effects were obtained.

A method for producing an insulating polymer material composition relating to Example 1 of the present invention will be discussed. The insulating polymer material composition was produced at a mixture ratio as shown in Table 1.

TABLE 1

| Raw material | Mixture amount | |
|---|---|---|
| Epoxidized linseed oil | 100 | phr |
| Pyrogallol | 35 | phr |
| Imidazole | 3 | phr |
| Fly ash | 250 | phr |
| Silane coupling agent | 0-2 | phf |

The unit phr as shown in Table 1 represents the weight of each of the mixture materials on the assumption that the weight of the epoxidized linseed oil is 100, while the unit phf represents the weight of each of the mixture materials on the assumption that the weight of the fly ash is 100. Speaking of the amount of each of the mixture materials, a good cured compound was obtained by mixing 5 to 80 phr of pyrogallol, 0.1 to 550 phr of fly ash, 0.01 to 5 phr of a silane coupling agent and 0.01 to 5 phr of 2E4MZ, relative to 100 phr of the epoxidized linseed oil. Furthermore, when pyrogallol was mixed in an amount of from 30 to 50 phr while mixing fly ash in an amount of from 150 to 350 phr, there could be obtained an insulating polymer material composition that can exhibit a good workability during a molding operation and excellent in insulating property.

First of all, an epoxidized linseed oil was mixed with pyrogallol and then heated to 80 to 180° C. and mixed with stirring, thereby obtaining a liquid epoxy resin composition. To the liquid epoxy resin composition, fly ash was added, and mixed with stirring. Thereafter a silane coupling agent and imidazole were added thereto and adequately mixed with stirring. The thus obtained resin composition was poured into a mold and underwent a defoaming process, followed by carrying out a heat treatment at 150° C. for 16 hours. With this the resin composition was cured, thereby obtaining an insulating polymer material composition relating to Example 1 of the present invention.

Conditions for curing the resin composition are not particularly limited. If the temperature is within a range of from 100 to 180° C., a good cured compound can be obtained. It is preferable to cure the composition at a temperature of from 100 to 170° C. A curing temperature and a curing time differ in optimal value according to the kind and the amount of the curing accelerator; therefore optimal values may suitably be selected according to materials constituting the insulating polymer material composition.

Then, a property evaluation was performed on the insulating polymer material composition relating to Example 1 of the present invention. The evaluation of the insulating polymer material composition was carried out in terms of: the maximum bending stress obtained by bending test; Tg serving as an index of heat resistance; and volume resistivity.

For bending test, a 5×10×80 mm rodlike specimen was prepared. Then, a three-point bending test in which the specimen was supported by two supporting rods and loaded at midpoint was performed to calculate the maximum bending stress. At this time, the span (or the distance between the supports) was 50 mm. Additionally, the specimen was subjected to a boiling treatment (boiling at 100° C. for 2 hours) in water, and the maximum bending stresses obtained before and after the boiling treatment were compared with each other thereby evaluating water resistance.

The cured compound produced upon heat treatment was cut into a shape of a 4 mmφ×15 mm cylindrical column and a TMA method is applied thereon. From an inflection point of linear expansivity obtained thereby, Tg was calculated.

Volume resistivity was obtained according to JIS K6911 at an impressed direct-current voltage of 1,000 V.

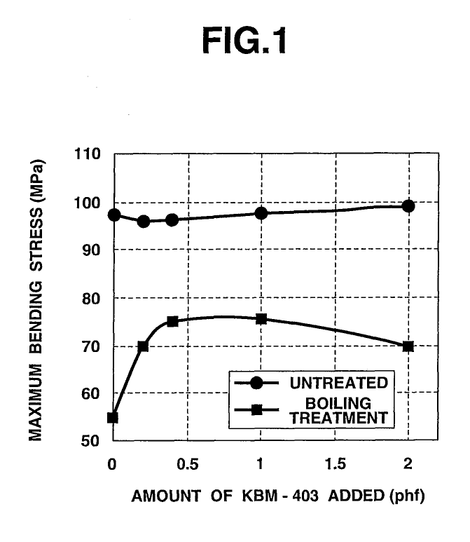

The influence of the amount of the added silane coupling agent upon the maximum bending stress of the insulating polymer material composition is shown by FIG. 1.

As shown in FIG. 1, water resistance was enhanced with the addition of the silane coupling agent. This is considered to result also from reduction of the concentration of unreacted phenolic hydroxyl groups remaining in the cured compound. Particularly when the amount of the added silane coupling agent was within a range of from 0.2 to 2 phf, there was exhibited a good water resistance.

Moreover, the influence of the amount of the added silane coupling agent upon properties of the insulating polymer material composition is shown by Table 2.

TABLE 2

| | Amount of added KBM-403 (phf) | | | | |
|---|---|---|---|---|---|
| Properties | 0 | 0.2 | 0.4 | 1 | 2 |
| Tg (° C.) | 55 | 65 | 78 | 75 | 75 |
| Volume | 40E+14 | 45E+14 | 45E+14 | 45E+14 | 45E+14 |
| resistivity | | | | | |
| (Ω · cm) | | | | | |

It is found from Table 2 that Tg and volume resistivity were enhanced with the addition of the silane coupling agent. This is considered because among phenolic hydroxyl groups, those not used for the curing reaction and remain were reacted with the silane coupling agent so as to improve the glass transition temperature (Tg). More specifically, the silane coupling agent having epoxy group allows the curing agent and fly ash to be bonded to each other so as to make the obtained insulating polymer material composition denser, thereby giving the effect of Tg improvement. However, it is not confirmed that Tg and volume resistivity are significantly changed with the amount of the added silane coupling agent.

In the insulating polymer material composition relating to Example 1 of the present invention, the silane coupling agent is added thereto to improve an interfacial property between epoxy resin and fly ash thereby improving the obtained insulating polymer material composition in property. Furthermore, derivatives of the plant-origin polyphenols relating to the present invention are compounds having two or more phenolic hydroxyl groups in one molecule; hence, among the phenolic hydroxyl groups, those not reacted with epoxy groups of the vegetable oil-origin epoxy resin form cross-linking with fly ash by virtue of the silane coupling agent having epoxy group, with which heat resistance (Tg) is enhanced and additionally the mechanical strength (the maximum bending stress) is enhanced. Moreover, when unreacted hydroxyl groups that remain in the resin are reacted with the silane coupling agent, water resistance and insulting properties are to be improved.

As discussed above, the use of the silane coupling agent improves an interfacial property between epoxy resin and fly ash. Therefore even if the amount of fly ash charged into the insulating polymer material composition is increased, an increase of the viscosity of the resin composition is suppressed. With this, the workability during a molding operation is improved and it becomes possible to fill the resin composition with inorganic fillers at high densities. In addition, water resistance of the insulating polymer material composition is enhanced. Furthermore, when the silane coupling agent having epoxy group is used, the curing agent and fly ash are chemically bonded to each other through the silane coupling agent thereby improving Tg. Accordingly, it contributes to improvement of the quality of the product.

### Example 2

An insulating polymer material composition relating to Example 2 of the present invention is a composition obtained by adding fly ash and a silane coupling agent to a plant-origin resin composition containing epoxidized linseed oil and pyrogallol. In Example 2, a silane coupling agent having amino group was added.

As a vegetable oil-origin epoxy resin, there was used an epoxidized linseed oil (an epoxidized linseed oil manufactured at Daicel Chemical Industries, Ltd. under the trade name of DIMAC L-500) belonging to an epoxidized vegetable oil. Meanwhile, pyrogallol (manufactured at Fuji Chemical Industry Co., Ltd.) serving as one kind of gallic acid derivatives was used as a curing agent for the epoxidized linseed oil.

Concerning fly ash, a II-type fly ash (manufactured at TechnoChubu Co., Ltd.) produced from fly ash ejected by Hekinan coal-fired power plant was used. Though there are some differences in property among aimed insulating polymer compositions according to differences of kind and particle size of fly ash, in every case a cured compound excellent in environmental property and in cost efficiency was obtained.

As the silane coupling agent, there was used a silane coupling agent having amino group. More specifically, KBM-573 and KBM-603 manufactured at Shin-Etsu Chemical Co., Ltd. were used.

As a curing accelerator, 2-ethyl-4-methylimidazole (manufactured at SHIKOKU CHEMICALS CORPORATION under the trade name of CUREZOL 2E4MZ) was used. Also in the case of using tertiary amine (manufactured at Meiden Chemical Co., Ltd. under the trade name of L-86) or aromatic amine (manufactured at Meiden Chemical Co., Ltd. under the trade name of K-61B) as the curing agent, similar effects were obtained.

A method for producing an insulating polymer material composition relating to Example 2 of the present invention will be discussed. The mixture ratio for the insulating polymer material composition relating to Example 2 of the present invention was the mixture ratio as shown in Table 1 made for Example 1. Speaking of the amount of each of the mixture materials, a good cured compound was obtained by mixing 5 to 80 phr of pyrogallol, 0.1 to 550 phr of fly ash, 0.01 to 5 phr of a silane coupling agent and 0.01 to 5 phr of 2E4MZ, relative to 100 phr of the epoxidized linseed oil. Furthermore, when pyrogallol was mixed in an amount of from 30 to 50 phr while mixing fly ash in an amount of from 150 to 350 phr, there could be obtained an insulating polymer material composition that can exhibit a good workability during a molding operation and excellent in insulating property.

First of all, an epoxidized linseed oil was mixed with pyrogallol and then heated to 80 to 180° C. and mixed with stirring, thereby obtaining a liquid epoxy resin composition. To the epoxy resin composition, fly ash was added, and mixed with stirring. Thereafter a silane coupling agent and imidazole were added thereto and adequately mixed with stirring. The thus obtained resin composition was poured into a mold and underwent a defoaming process, followed by carrying out a heat treatment at 150° C. for 16 hours. With this the resin composition was cured, thereby obtaining an insulating polymer material composition relating to Example 2 of the present invention.

Conditions for curing the resin composition are not particularly limited. If the temperature is within a range of from 100 to 180° C., a good cured compound can be obtained. It is preferable to cure the composition at a temperature of from 100 to 170° C. A curing temperature and a curing time differ in optimal value according to the kind and the amount of the curing accelerator; therefore optimal values may suitably be selected according to materials constituting the insulating polymer material composition.

Then, a property evaluation was performed on the insulating polymer material composition relating to Example 2 of the present invention. The evaluation of the insulating polymer material composition was carried out in terms of; the maximum bending stress obtained by bending test; Tg serving as an index of heat resistance; and volume resistivity.

For bending test, a 5×10×80 mm rodlike specimen was prepared. Then, a three-point bending test in which the specimen was supported by two supporting rods and loaded at midpoint was performed to calculate the maximum bending stress. At this time, the span (or the distance between the supports) was 50 mm. Additionally, the specimen was subjected to a boiling treatment (boiling at 100° C. for 2 hours) in water, and the maximum bending stresses obtained before and after the boiling treatment were compared with each other thereby evaluating water resistance.

The cured compound produced upon heat treatment was cut into a shape of a 4 mmφ×15 mm cylindrical column and a TMA method is applied thereon. From an inflection point of linear expansivity obtained thereby, Tg was calculated.

Volume resistivity was obtained according to JIS K6911 at an impressed direct-current voltage of 1,000 V.

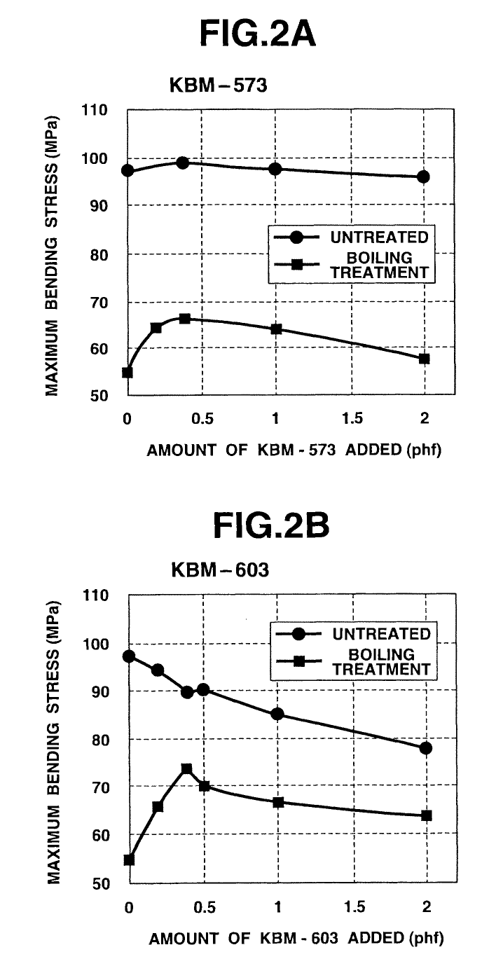

The influence of the amount of the added silane coupling agent upon the maximum bending stress of the insulating polymer material composition is shown by FIG. 2(a) and FIG. 2(b).

As shown in FIG. 2(a) and FIG. 2(b), water resistance was enhanced with the addition of the silane coupling agent. This is considered to result also from the bond among the silane coupling agent, epoxy resin and fly ash. Particularly when the amount of the added silane coupling agent was within a range of from 0.2 to 2 phf, there was exhibited a good water resistance.

Incidentally, it is found from the result as shown in FIG. 2(b) that the maximum bending stress is reduced with the addition of KBM-603. Therefore, it is preferable to add the silane coupling agent with consideration given to properties expected to finally be obtained.

Additionally, the influence of the amount of the added silane coupling agent upon properties of the insulating polymer material composition is shown by Table 3 and Table 4.

TABLE 3

| | Amount of added KBM-573 (phf) | | | | |
|---|---|---|---|---|---|
| Properties | 0 | 0.2 | 0.4 | 1 | 2 |
| Tg (° C.) | 55 | 65 | 73 | 70 | 70 |
| Volume | 40E+14 | 45E+14 | 45E+14 | 45E+14 | 45E+14 |
| resistivity | | | | | |
| (Ω · cm) | | | | | |

TABLE 4

| | Amount of added KBM-603 (phf) | | | | |
|---|---|---|---|---|---|
| Properties | 0 | 0.2 | 0.4 | 1 | 2 |
| Tg (° C.) | 55 | 60 | 65 | 65 | 62 |
| Volume | 40E+14 | 45E+14 | 45E+14 | 45E+14 | 45E+14 |
| resistivity | | | | | |
| (Ω · cm) | | | | | |

As shown in Table 3 and Table 4, with the addition of the silane coupling agent, Tg was enhanced and volume resistivity was enhanced. More specifically, the use of the silane coupling agent improves an interfacial property between epoxy resin and fly ash. Therefore even if the amount of fly ash charged into the insulating polymer material composition is increased, an increase of the viscosity of the resin composition is suppressed. With this, the workability during a molding operation is improved and it becomes possible to fill the resin composition with inorganic fillers at high densities. In addition, water resistance of the insulating polymer material composition is enhanced. However, it is not confirmed that Tg and volume resistivity are significantly changed with the amount of the added silane coupling agent.

### Example 3

An insulating polymer material composition relating to Example 3 of the present invention is a composition obtained by adding fly ash and a silane coupling agent to a plant-origin resin composition containing epoxidized linseed oil and pyrogallol. In Example 3, a silane coupling agent having mercapto group was added.

As a vegetable oil-origin epoxy resin, there was used an epoxidized linseed oil (an epoxidized linseed oil manufactured at Daicel Chemical Industries, Ltd. under the trade name of DIMAC L-500) belonging to an epoxidized vegetable oil. Meanwhile, pyrogallol (manufactured at Fuji Chemical Industry Co., Ltd.) serving as one kind of gallic acid derivatives was used as a curing agent for the epoxidized linseed oil.

Concerning fly ash, a II-type fly ash (manufactured at TechnoChubu Co., Ltd.) produced from fly ash ejected by Hekinan coal-fired power plant was used. Though there are some differences in property among aimed insulating polymer material compositions according to differences of kind and particle size of fly ash, in every case a cured compound excellent in environmental property and in cost efficiency was obtained.

As the silane coupling agent, there was used a silane coupling agent having mercapto group. More specifically, KBM-803 manufactured at Shin-Etsu Chemical Co., Ltd. was used.

As a curing accelerator, 2-ethyl-4-methylimidazole (manufactured at SHIKOKU CHEMICALS CORPORATION under the trade name of CUREZOL 2E4MZ) was used. Also in the case of using tertiary amine (manufactured at Meiden Chemical Co., Ltd. under the trade name of L-86) or aromatic amine (manufactured at Meiden Chemical Co., Ltd. under the trade name of K-61B) as the curing agent, similar effects were obtained.

A method for producing an insulating polymer material composition relating to Example 3 of the present invention will be discussed. The mixture ratio for the insulating polymer material composition relating to Example 3 of the present invention was the mixture ratio as shown in Table 1 made for Example 1. Speaking of the amount of each of the mixture materials, a good cured compound was obtained by mixing 5 to 80 phr of pyrogallol, 0.1 to 550 phr of fly ash, 0.01 to 5 phr of a silane coupling agent and 0.01 to 5 phr of 2E4MZ, relative to 100 phr of the epoxidized linseed oil. Furthermore, when pyrogallol was mixed in an amount of from 30 to 50 phr while mixing fly ash in an amount of from 150 to 350 phr, there could be obtained an insulating polymer material composition that can exhibit a good workability during a molding operation and excellent in insulating property.

First of all, an epoxidized linseed oil was mixed with pyrogallol and then heated to 80 to 180° C. and mixed with stirring, thereby obtaining a liquid epoxy resin composition. To the liquid epoxy resin composition, fly ash was added, and mixed with stirring. Thereafter a silane coupling agent and imidazole were added thereto and adequately mixed with stirring. The thus obtained resin composition was poured into a mold and underwent a defoaming process, followed by carrying out a heat treatment at 150° C. for 16 hours. With this the resin composition was cured, thereby obtaining an insulating polymer material composition relating to Example 3 of the present invention.

Conditions for curing the resin composition are not particularly limited. If the temperature is within a range of from 100 to 180° C., a good cured compound can be obtained. It is preferable to cure the composition at a temperature of from 100 to 170° C. A curing temperature and a curing time differ in optimal value according to the kind and the amount of the curing accelerator; therefore optimal values may suitably be selected according to materials constituting the insulating polymer material composition.

Then, a property evaluation was performed on the insulating polymer material composition relating to Example 3 of the present invention. The evaluation of the insulating polymer material composition was carried out in terms of: the maximum bending stress obtained by bending test; Tg serving as an index of heat resistance; and volume resistivity.

For bending test, a 5×10×80 mm rodlike specimen was prepared. Then, a three-point bending test in which the specimen was supported by two supporting rods and loaded at midpoint was performed to calculate the maximum bending stress. At this time, the span (or the distance between the supports) was 50 mm. Additionally, the specimen was subjected to a boiling treatment (boiling at 100° C. for 2 hours) in water, and the maximum bending stresses obtained before and after the boiling treatment were compared with each other thereby evaluating water resistance.

The cured compound produced upon heat treatment was cut into a shape of a 4 mmφ×15 mm cylindrical column and a TMA method is applied thereon. From an inflection point of linear expansivity obtained thereby, Tg was calculated.

Volume resistivity was obtained according to JIS K6911 at an impressed direct-current voltage of 1,000 V.

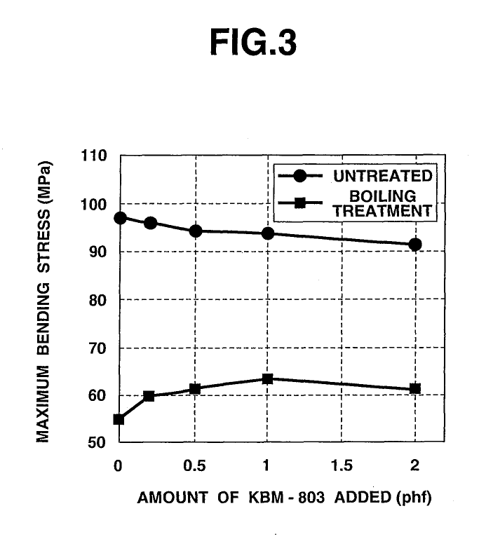

The influence of the amount of the added silane coupling agent upon the maximum bending stress of the insulating polymer material composition is shown by FIG. 3.

As shown in FIG. 3, water resistance was enhanced with the addition of the silane coupling agent. This is considered to result also from the bond among the silane coupling agent, epoxy resin and fly ash. Particularly when the amount of the added silane coupling agent was within a range of from 0.2 to 2 phf, there was exhibited a good water resistance.

Additionally, the influence of the amount of the added silane coupling agent upon properties of the insulating polymer material composition is shown by Table 5.

TABLE 5

| | Amount of added KBM-803 (phf) | | | | |
|---|---|---|---|---|---|
| Properties | 0 | 0.2 | 0.4 | 1 | 2 |
| Tg (° C.) | 55 | 60 | 60 | 55 | 55 |
| Volume | 40E+14 | 45E+14 | 45E+14 | 45E+14 | 45E+14 |
| resistivity | | | | | |
| (Ω · cm) | | | | | |

As shown in Table 5, with the addition of the silane coupling agent, Tg was enhanced and volume resistivity was enhanced. More specifically, the use of the silane coupling agent improves an interfacial property between epoxy resin and fly ash. Therefore even if the amount of fly ash charged into the insulating polymer material composition is increased, an increase of the viscosity of the resin composition is suppressed. With this, the workability during a molding operation is improved and it becomes possible to fill the resin composition with inorganic fillers at high densities. In addition, water resistance of the insulating polymer material composition is enhanced. However, it is not confirmed that Tg and volume resistivity are significantly changed with the amount of the added silane coupling agent.

Mercapto group is such as to be excellent in reactivity with metal components of fly ash. Therefore, by adding the silane coupling agent having mercapto group, it becomes possible to prevent the metal components from leaking from the cured compound.

The principal component of the fly ash used in Example 3 included 55% of silicon oxide, 25% of aluminium oxide, 5.5% of ferric oxide, 3% of calcium oxide, and 1.5% of magnesium oxide. Hence, by adding a silane coupling agent suitable for the components of the fly ash, it becomes possible to improve the cured compound in various properties.

As discussed by citing Examples 1 to 3, the insulating polymer material composition of the present invention uses nonpetroleum materials, i.e., a vegetable oil-origin epoxy resin and a plant-origin polyphenol derivative as raw materials, and has a Tg of not lower than room temperature and gives a cured compound (an insulating polymer material composition) excellent in insulating property. Additionally, since a compatibilized blend of the vegetable oil-origin epoxy resin and the plant-origin polyphenol derivative is cured with the addition of coal ash and a silane coupling agent, it is possible to obtain an insulating polymer material composition in which heat resistance, mechanical strength and water resistance are improved as compared with a cured compound obtained from a conventional nonpetroleum material.

Further, as proved by Examples 1 to 3, the obtained insulating polymer material composition is to differ in property according to the kind of the added silane coupling agent, so that it may suitably be used in combination with a silane coupling required according to the purpose.

The insulating polymer material composition of the present invention uses nonpetroleum materials as the raw materials; therefore, it is a carbon neutral insulating polymer material composition. Additionally, coal ash is waste and therefore excellent in cost efficiency, which allows the cost of the raw materials to be reduced. In other words, the insulating polymer material composition of the present invention accomplishes an environment-conscious type insulating material the principal materials of which are a plant-origin material and waste.

In addition, the insulating polymer material composition relating to the present invention can be applied to insulating materials for use in electric devices and the like. For example, it can be applied to epoxy mold products in general, such as an insulating spacer, a supporting insulator, an insulating frame, an insulating sheet, mold devices used in a solid-insulated switchgear (a miniclad) and a gas-insulated device, mold resins used in transformers, and the like. Incidentally, the uses of the insulating polymer material composition of the present invention are not limited to the above-mentioned insulating materials for electric devices, so that the insulating polymer material composition can be applied to various uses as an insulating member.

1. An insulating polymer material composition characterized by comprising:
one or more kinds of epoxidized vegetable oil;
one or more kinds of plant-origin polyphenol derivative;
coal ash; and
a silane coupling agent.

2. An insulating polymer material composition as claimed in claim 1, characterized in that the epoxidized vegetable oil is an epoxidized linseed oil.

3. An insulating polymer material composition as claimed in claim 1, characterized in that the plant-origin polyphenol derivative has two or more hydroxyl groups in one molecule.

4. An insulating polymer material composition as claimed in claim 1, characterized in that the plant-origin polyphenol derivative is a gallic acid derivative.

5. An insulating polymer material composition as claimed in claim 4, characterized in that the gallic acid derivative contains any one or more kinds of pyrogallol, methyl gallate, ethyl gallate, propyl gallate, isopropyl gallate, pentyl gallate, isopentyl gallate, hexadecyl gallate, heptadecyl gallate and octadecyl gallate.

6. An insulating polymer material composition as claimed in claim 1, characterized in that the plant-origin polyphenol derivative is lignin.

7. An insulating polymer material composition as claimed in claim 1, characterized in that the silane coupling agent has an epoxy group.

8. An insulating polymer material composition as claimed in claim 1, characterized in that the silane coupling agent has a mercapto group.

9. An insulating polymer material composition as claimed in claim 1, characterized in that the silane coupling agent is a combination of two or more kinds of silane coupling agent.

10. An electric device including at least at a part thereof an insulating polymer material composition as claimed in claim 1.
